(19) United States
(12) Patent Application Publication
(10) Pub. No.: US 2010/0205203 A1
(43) Pub. Date: Aug. 12, 2010

(54) Systems and methods for video analysis

(75) Inventors: Doug Anderson, Campbell, CA (US); Ryan Case, San Francisco, CA (US); Rob Haitani, Menlo Park, CA (US); Bob Petersen, Santa Clara, CA (US)

Correspondence Address: CARR & FERRELL LLP, 2200 GENG ROAD, PALO ALTO, CA, 94303, US

(73) Assignee: Vitamin D, Inc.

(21) Appl. No.: 12/378,029

(22) Filed: Feb. 9, 2009

(51) Int. Cl. G06F 17/30

(52) U.S. Cl. 707/769; 707/E17.108; 707/754

(57) ABSTRACT

Embodiments of systems and methods for video analysis are given. A method for providing a video analysis includes four steps. A target is identified by a computing device and is displayed from a video through a display of the computing device. A query related to the identified target is received via a user input to the computing device. A search result is generated based on the video. The search result includes information related to the identified target. The search result is then displayed through the display of the computing device.

### CROSS-REFERENCE TO RELATED APPLICATIONS

This application is related to the U.S. patent application Ser. No. ______ filed on Feb. 9, 2009, titled “Systems and Methods for Video Monitoring,” which is hereby incorporated by reference.

### SUMMARY OF THE INVENTION

Embodiments of systems and methods for video analysis are provided herein. In a first embodiment, a method for providing an analysis includes four steps. The first step is the step of identifying a target by a computing device. The target is displayed from a video through a display of the computing device. The second step of the method is the step of receiving a query related to the identified target via a user input to the computing device. The third step of the method is the step of generating a search result based on the video. The search result comprises information relating to the identified target. The fourth step is the step of displaying the search result through the display of the computing device.

In a second embodiment, a system for video analysis is provided. The system includes a target identification module, an interface module, a search result module, and a display module. The target identification module is configured for identifying a target from the video supplied to a computing device. The interface module is in communication with the target identification module. The interface module is configured for receiving a query related to the identified target via a user input to the computing device. The search result module is in communication with the interface module. The search result module is configured to generate a search result based on the video. The search result comprises information related to the identified target. The display module is in communication with the search result module. The display module is configured to display the search result through the display of the computing device.

According to a third embodiment, a system for generating a search result based on an analysis is supplied. The system includes a processor and a computer readable storage medium. The computer readable storage medium includes instructions for execution by the processor which causes the processor to provide a response. The processor is coupled to the computer readable storage medium. The processor executes the instructions on the computer readable storage medium to identify a target from a video supplied to a computing device, receive a query related to the identified target, and generate the search result based on the video. The search result comprises information related to the identified target.

### BRIEF DESCRIPTION OF THE DRAWINGS

FIG. 1 is a diagram of an exemplary network environment for a system for video analysis.

FIG. 2 is a flow chart showing an exemplary method of providing a video analysis.

FIG. 3 is a diagram of an exemplary architecture of a system for video analysis.

FIG. 4 is an exemplary screenshot of a display on a computing device interacting with some of the various embodiments disclosed herein.

FIG. 5 is a second exemplary screenshot of a display on a computing device interacting with some of the various embodiments disclosed herein.

FIG. 6 is a third exemplary screenshot of a display on a computing device interacting with some of the various embodiments disclosed herein.

FIG. 7 is an exemplary screenshot of a display on a computing device during a quick search using some of the various embodiments disclosed herein.

FIG. 8 is an exemplary screenshot of a display on a computing device during a rule search using some of the various embodiments disclosed herein.

FIG. 9 is an exemplary screenshot of a pop-up alert displayed on a display of a computing device using some of the various embodiments disclosed herein.

### DETAILED DESCRIPTION OF THE INVENTION

There are inherent difficulties associated with searching and analyzing data using existing technologies. Existing technologies are time-consuming, inconvenient, unreliable, and provide false positives. Furthermore, existing technologies have a tendency not to be helpful insofar that they cannot reduce or filter a large set of data to a meaningful subset for presentation to a user.

In contrast, the technology presented herein provides embodiments of systems and methods for providing analysis in a convenient and meaningful presentation that is beneficial to the user. Specifically, systems and methods for providing data analysis and generating reliable search results are provided herein. Such systems and methods may be based on queries. Queries may include rules that may be configurable by the user. In other words, the user may be given the flexibility to define the rules. Such user-defined rules may be created, saved, edited, and re-applied to data of any type, including but not limited to data streams, data archives, and data presentations. The technology provided herein may be user-extensible. For instance, the user is provided with the means to define rules, searches, and user selections (such as user selections regarding data sources, cameras, targets, triggers, responses, time frames, and the like).

Moreover, the technology described herein provides systems and methods for providing the user with a selection of existing rules and/or time frames to execute searches. Also, data may be pre-processed to generate metadata, which may then be searched with one or more rules. For instance, metadata in video may be searched using user-configurable rules for both real-time and archive searches. As will be described in greater detail herein, metadata in video may be associated with camera, target and/or trigger attributes of a target that is logged for processing, analyzing, reporting and/or data mining methodologies. Metadata may be extracted, filtered, presented, and used as keywords for searches. Metadata in video may also be accessible to external applications.

The technology herein may also utilize, manipulate, or display metadata for searching data archives. In some embodiments, the metadata may be associated with a video. For instance, metadata in a video may be useful to define and/or recognize triggered events according to rules that are established by a user. Metadata may also be useful to provide only those videos or video clips that conform to, the parameters set by a user through rules. By doing this, videos or video clips that only include triggered events as identified by the user are provided to the user. Thus, the user is not presented with a search result having hundreds or thousands of videos, but rather a much smaller set of videos that meet the user's requirements as set forth in rules. Further discussion regarding the use of metadata in video will be provided herein.

The technology may be implemented through a variety of means, such as object recognition, artificial intelligence, hierarchical temporal memory (HTM), any technology that recognizes patterns found in objects, and any technology that can establish categories of objects. However, one skilled in the art will recognize that this list is simply an exemplary one and the technology is not limited to a single type of implementation.

One skilled in the art will recognize that although some embodiments are provided herein for video analysis, any type of analysis from any data source may be utilized with this technology. For instance, instead of a video source, an external data source (such as a web-based data source in the form of a news feed) may be provided instead. The technology is flexible to utilize any data source, and is not restricted to only video sources or video streams.

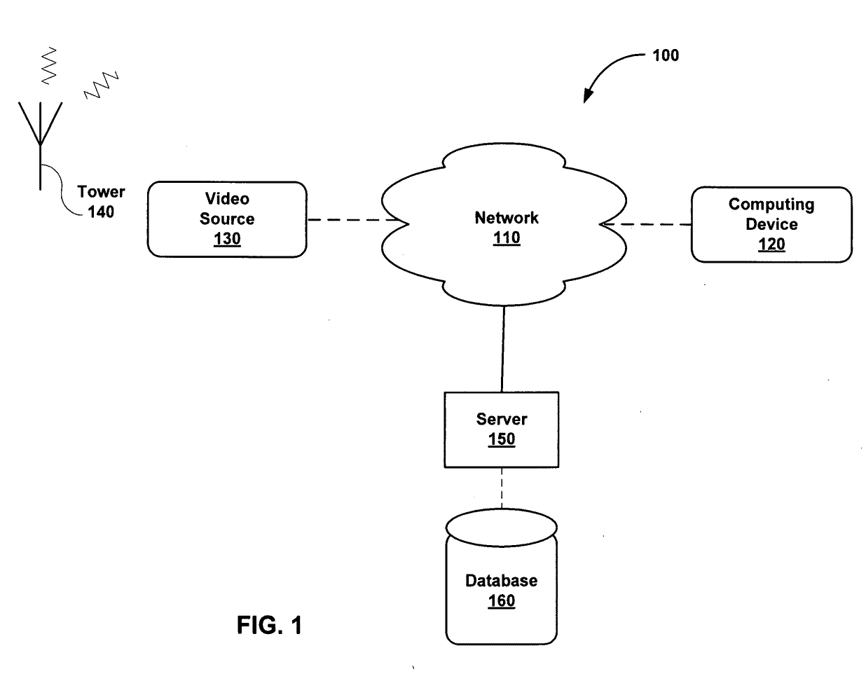

FIG. 1 depicts an exemplary networking environment 100 for a system that provides video analysis. Like numbered elements in the figures refer to like elements. The exemplary networking environment 100 includes a network 110, one or more computing devices 120, one or more video sources 130, one or more optional towers 140, a server 150, and an optional external database 160. The network 110 may be the Internet, a mobile network, a local area network, a home network, or any combination thereof. The network 110 is configured to couple with one or more computing devices 120.

The computing device 120 may be a computer, a laptop computer, a desktop computer, a mobile communications device, a personal digital assistant, a video player, an entertainment device, a game console, a GPS device, a networked sensor, a card key reader, a credit card reader, a digital device, a digital computing device and any combination thereof. The computing device 120 preferably includes a display (not shown). One skilled in the art will recognize that a display may include one or more browsers, one or more user interfaces, and any combination thereof. The display of the computing device 120 may be configured to show one or more videos. A video may be a video feed, a video scene, a captured video, a video clip, a video recording, or any combination thereof.

The network 110 may also be configured to couple to one or more video sources 130. The video may be provided by one or more video sources 130, such as a camera, a fixed security camera, a video camera, a video recording device, a mobile video recorder, a webcam, an IP camera, pre-recorded data (e.g., pre-recorded data on a DVD or a CD), previously stored data (including, but not limited to, previously stored data on a database or server), archived data (including but not limited to, video archives or historical data), and any combination thereof. The computing device 120 may be a mobile communications device that is configured to receive and transmit signals via one or more optional towers 140.

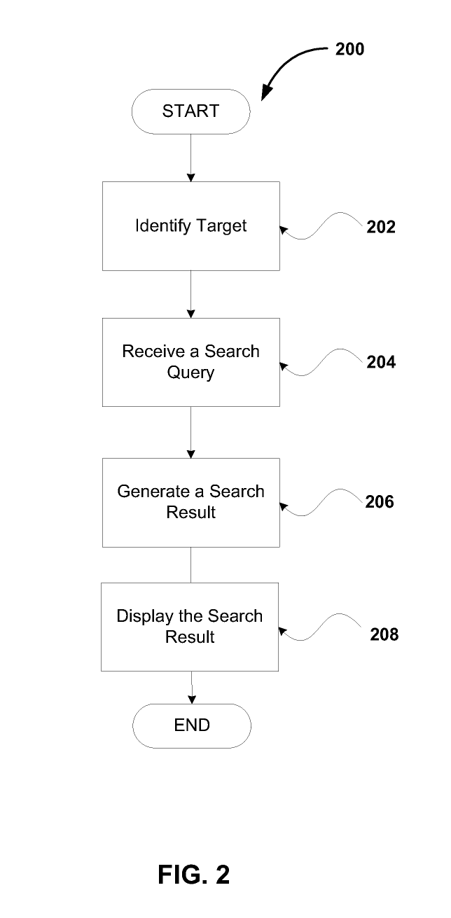

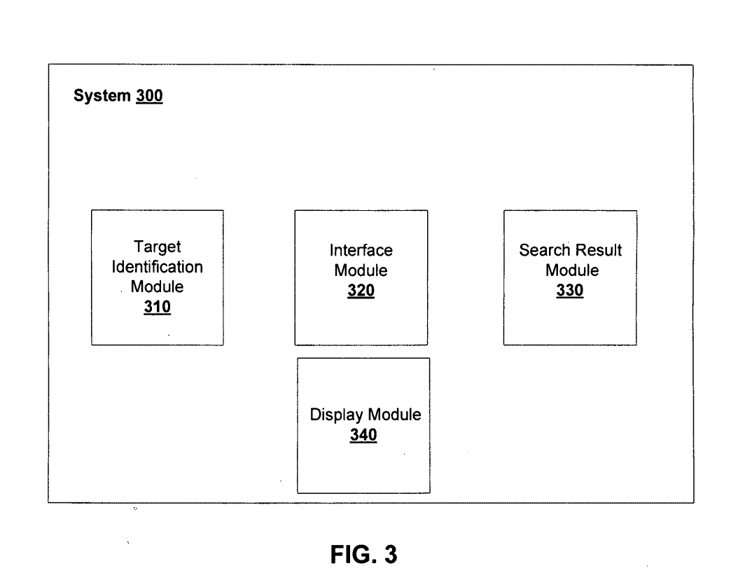

Still referring to FIG. 1, the network 110 may be configured to couple to the server 150. As will be described herein, the server 150 may use one or more exemplary methods (such as the method 200 shown in FIG. 2). The server 150 may also be included in one or more exemplary systems described herein (such as the system 300 shown in FIG. 3). The server 150 may include an internal database to store data. One or more optional external databases 160 may be configured to couple to the server 150 for storage purposes.

Notably, one skilled in the art can recognize that all the figures herein are exemplary. For all the figures, the layout, arrangement and the number of elements depicted are exemplary only. Any number of elements may be used to implement the technology of the embodiments herein. For instance, in FIG. 1, although one computing device 120 is shown, the technology allows for the network 110 to couple to one or more computing devices 120. Likewise, although one network 110 and one server 150 are shown in FIG. 1, one skilled in the art can appreciate that more than one network and/or more than one server may be utilized and still fall within the scope of various embodiments. Also, although FIG. 1 includes dotted lines to show relationships between elements, such relationships are exemplary. For instance, FIG. 1 shows that the video source 130 is coupled to the network 110, and the computing device 120 is coupled to the network 110. However, the various embodiments described herein also encompass any networking environment where one or more video sources 130 are coupled to the computing device 120, and the computing device 120 is coupled to the network 110. Further details as to various embodiments of the system 100 of FIG. 1 can be found in the U.S. patent application Ser. No. ______ filed on Feb. 9, 2009, titled “Systems and Methods for Video Monitoring,” which is hereby incorporated by reference.

Turning to FIG. 2, an exemplary method 200 for providing video analysis is shown. The method 200 may include four steps. At step 202, a target is identified. At step 204, a query related to the identified target is received via a user input to the computing device. At step 206, a search result is generated. The search result may be based on any type of data. The search result may be based on one or more videos. The search result includes information related to the identified target. At step 208, the search result is displayed. The search result may be displayed through the display of the computing device. As with all the methods described herein, the steps of method 200 are exemplary and may be combined, omitted, skipped, repeated, and/or modified.

Any aspect of the method 200 may be user-extensible. For example, the target, the query, the search result, and any combination thereof may be user-extensible. The user may therefore define any aspect of the method 200 to suit his requirements for analysis. The feature of user-extensibility allows for this technology to be more robust and more flexible than the existing technology. Users may combine targets, queries, and search results in various combinations to achieve customized results.

Still referring to FIG. 2, at step 202, the target is identified by a computing device 120. The target is displayed from a video through a display of the computing device 120. The target may include one of a recognized object, a motion sequence, a state, and any combination thereof. The recognized object may be a person, a pet or a vehicle. As will be discussed later herein, a motion sequence may be a series of actions that are being targeted for identification. A state may be a condition or mode (such as the state of a flooded basement, an open window, or a machine when a belt has fallen off). Further information regarding target identification is provided in the U.S. patent application Ser. No. ______ filed on Feb. 9, 2009, titled “Systems and Methods for Video Monitoring,” which is hereby incorporated by reference.

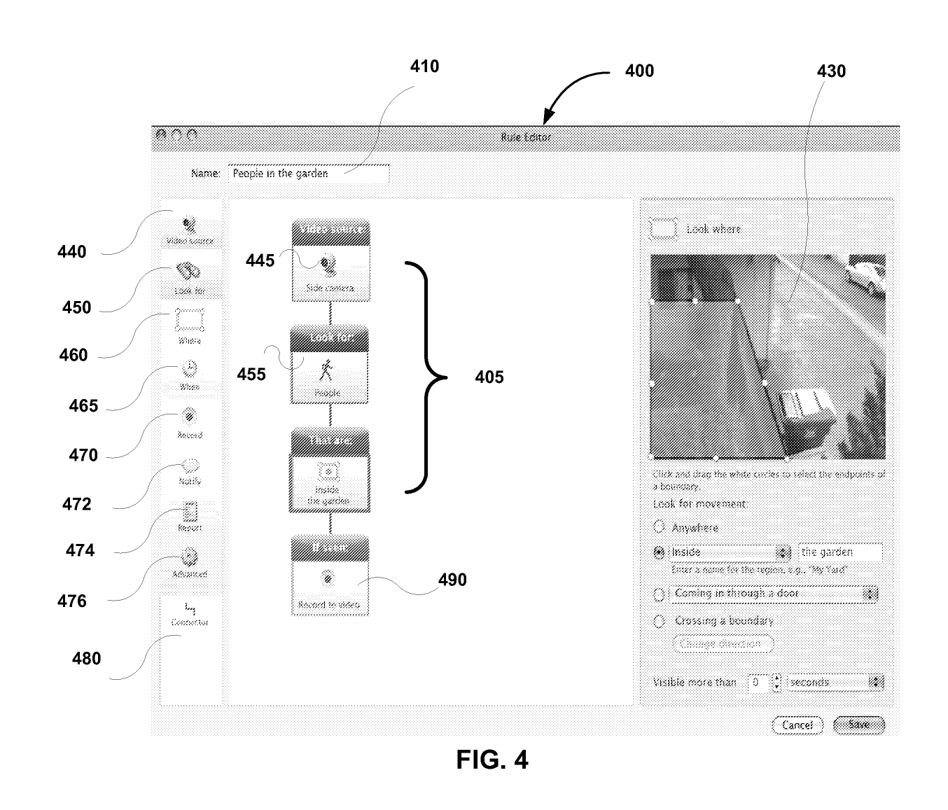

Also, at step 202, identifying the target from a video may include receiving a selection of a predefined object. For instance, preprogrammed icons depicting certain objects (such as a person, a pet or a vehicle) that have already been learned and/or otherwise identified by the software program may be shown to the user through a display of the computing device 120. Thus, the user may then select a predefined object (such as a person, a pet or a vehicle) by selecting the icon that best matches the target. Once a user selects an icon of the target, the user may drag and drop the icon onto another portion of the display of the computing device, such that the icon (sometimes referred to as a block) may be rendered on the display. Thus, the icon may become part of a rule (such as the rule 405 shown in FIG. 4). For instance, if the user selects people as the target, an icon of “Look for: People” (such as the icon 455 of FIG. 4) may be rendered on the display of the computing device. In further embodiments, one or more icons may be added such that the one or more icons may be rendered on the display via a user interface. Exemplary user interfaces include, but are not limited to, “Add” button(s), drop down menu(s), menu command(s), one or more radio button(s), and any combination thereof. One skilled in the art will recognize that any type of user interface may be used with this technology. Similarly, one or more icons may be removed from the display or modified as rendered on the display, through a user interface.

The technology allows for user-extensibility for defining targets. For instance, a user may “teach” the technology how to recognize new objects by assigning information (such as labels or tags) to clips of video that include the new objects. Thus, a software program may “learn” the differences between categories of pets, such as cats and dogs, or even categories of persons, such as adults, infants, men, and women. Alternatively, at step 202, identifying the target from a video may include recognizing an object based on a pattern. For instance, facial patterns (frowns, smiles, grimaces, smirks, and the like) of a person or a pet may be recognized.

Through such recognition based on a pattern, a category may be established. For instance, a category of various human smiles may be established through the learning process of the software. Likewise, a category of variety of human frowns may be established by the software. Further, a behavior of a target may be recognized. Thus, the software may establish any type of behavior of a target, such as the behavior of a target when the target is resting or fidgeting. The software may be trained to recognize new or previously unknown objects. The software may be programmed to recognize new actions, new behaviors, new states, and/or any changes in actions, behaviors or states. The software may also be programmed to recognize metadata from video and provide the metadata to the user through the display of a computing device 120.

In the case where the target is a motion sequence, the motion sequence may be a series of actions that are being targeted for identification. One example of a motion sequence is the sequence of lifting a rock and tossing the rock through a window. Such a motion sequence may be preprogrammed as a target. However, as described earlier, targets may be user-extensible. Thus, the technology allows for users to extend the set of targets to include targets that were not previously recognized by the program. For instance, in some embodiments, targets may include previously unrecognized motion sequences, such as the motion sequence of kicking a door down. Also, targets may even include visual, audio, and both visual-audio targets. Thus, the software program may be taught to recognize a baby's face versus an adult female's face. The program may be taught to recognize a baby's voice versus an adult female's voice.

At step 204, a query related to the identified target is received via a user input to the computing device 120. The query may be stored on a computer readable storage medium (not shown). The query may include one or more user-defined rules. Rules may include source selection (such as video source selection), triggers, and responses. Rules are described in further detail in the U.S. patent application Ser. No. ______ filed on Feb. 9, 2009, titled “Systems and Methods for Video Monitoring,” which is hereby incorporated by reference.

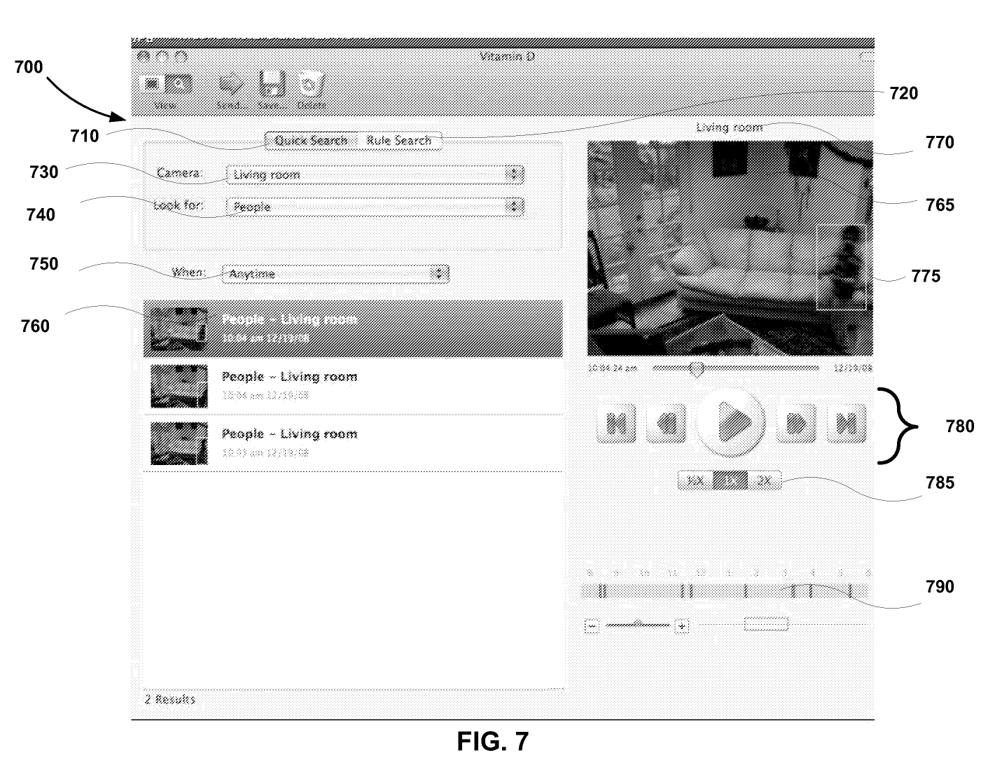

The query may include an instruction to provide one or more clips of one or more videos based on a specific time period or time frame. One skilled in the art will recognize that the time period can be of any measurement, including but not limited to days, weeks, hours, minutes, seconds, and the like. For instance, the query may include an instruction to provide all video clips within the last 24 hours. Another example is the query may include an instruction to provide all video clips for the last 2 Thursdays. Alternatively, the query may include an instruction to provide all video clips regardless of a video timestamp. This is exemplified by a time duration field 760 showing “When: Anytime” in FIG. 7. Thus, a user may define or designate a time period that he is interested to view videos. Metadata from a video, including but not limited to time stamp and video properties relating to duration, may be extracted from the video. Such extracted metadata may then be used to determine whether a video or a clip of a video falls within a specific time period as defined in a query.

The query may include an instruction to provide one or more videos from one or more video sources. A user may define which video source(s) should be included in the query. An example is found in FIG. 7, where the user designated in a location field 730 that video from a camera in a living room should be the video source (“Camera: Living room”). In FIG. 7, a drop down menu is provided for the location field 730 so that a user may select which camera is included in the query. However, one skilled in the art can recognize that the a user may define a video source through any type of user input to a computing device 120, and the technology is not limited to only drop down menus for user selection of video sources.

The query may comprise an instruction to provide a video clip regarding the identified target. The identified target may include one or more persons, vehicles or pets. The identified target may be a user-defined target. User-defined targets are discussed at length in the U.S. patent application Ser. No. ______ filed on Feb. 9, 2009, titled “Systems and Methods for Video Monitoring,” which is hereby incorporated by reference. The query may include an instruction to provide a video clip showing an identified target within a region. For instance, a query may include an instruction to provide video clips that show people within a region designated by the user. The user may designate a region by drawing a box (such as a bounding box), circle or other shape around a region that can be viewed by a video source.

At step 206, a search result is generated. As mentioned previously, the search result may be based on any type of data. The search result may be based on one or more videos captured by one or more video sources. The search result may include information related to the identified target. Generating the search result may include filtering the video based on the query. One skilled in the art will recognize that there is a multitude of ways to filter videos. For instance, filtering videos based on a query can be accomplished by using metadata that is associated with the videos being analyzed. As discussed previously, this technology may extract, identify, utilize and determine the metadata that is associated with videos. Due to the object recognition aspects and the sophisticated higher level learning of this technology, the metadata may include metadata relating to identified targets, attributes regarding identified targets, timestamps of videos or clips of videos, source settings (such as video source location or camera location), recognized behaviors, patterns, states, motion sequences, user-defined regions as captured by videos, and any further information that may be garnered to execute a query. One skilled in the art will recognize that this list of metadata that can be determined by this technology is non-exhaustive and is exemplary.

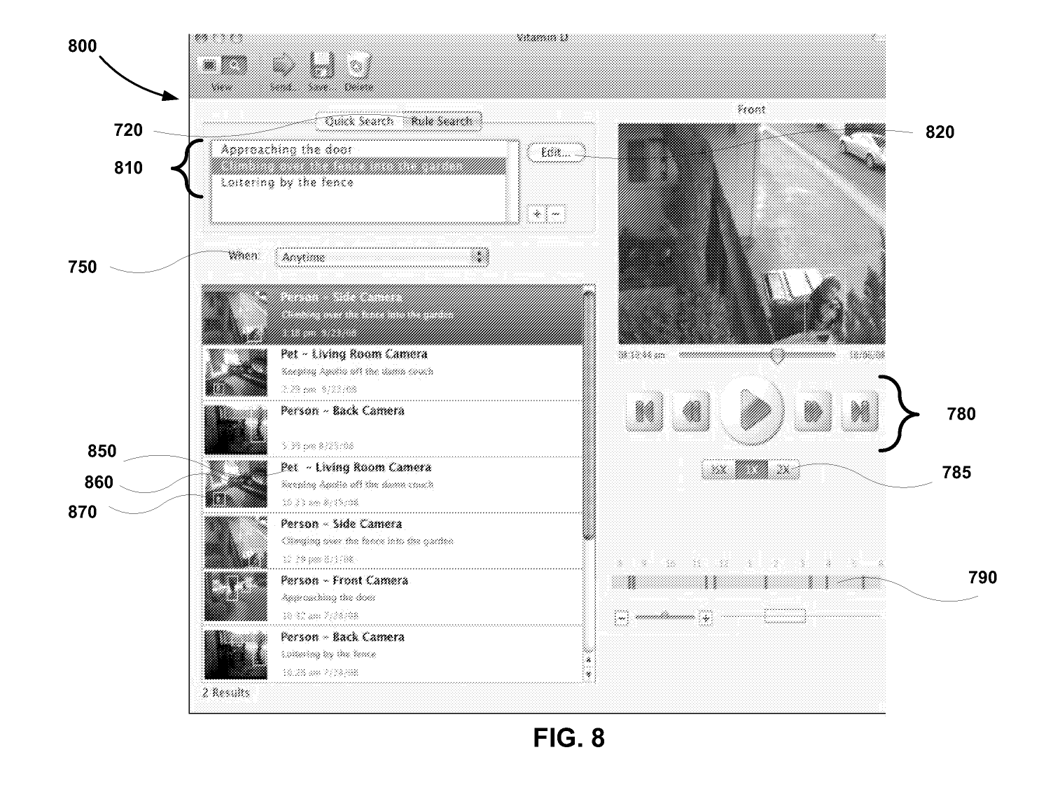

Still referring to step 206, generating the search result may include providing one or more video clips with a text description of the information related to the identified target. The text description of a given video clip may be all or part of a query, a rule, and/or metadata associated with the video clip. For instance, based on the object recognition aspects of this technology, the technology may recognize a user's pet dog. If the user's pet dog is seen moving in a designated region based on a video, then the generation of the search result may include providing the video clip of the dog in the region with the location of the video source. In FIG. 8, the text description of “Pet—Living Room Camera” 850 is given to a video clip that shows the user's pet moving in a region of the living room. The video clip may be represented with a thumbnail 860 of a frame where the identified target (pet) matched the executed search query.

The text description may include further information about the identified target, based on a query, a rule and/or metadata associated with the video clip. For instance, the thumbnail 860 of the video clips of “Pet—Living Room Camera” 850 (as shown in FIG. 8) has further text that provides the name of the pet (Apollo) and the region that the user designated (couch). With object recognition and higher-level learning capabilities, the technology may be able to distinguish the pet Apollo from another pet in the user's household.

Generating the search result may include providing a thumbnail of the video or video clip which may include a bounding box of the identified target that matched an executed search query. In the previous example, the bounding box 870 of the identified target (a pet named Apollo) is shown to the user on the display of a computing device. Alternatively, generating the search result may show a frame where the identified target matched an executed search query (such as the frame 860 of the pet Apollo in FIG. 8). Generating a search result may include providing a timeline showing triggered events that occur within a specified time period, as shown in the video clip. Further discussion regarding timelines and triggered events is provided later.

At step 208, the search result is displayed to the user. The search result may be displayed to the user on a display of a computing device 120. The search result may be presented in any format or presentation. One type of format is displaying the search results in a list with thumbnails for each of the video clips that match the search query or criteria, as described earlier herein. Both FIGS. 7 and 8 show lists of search results. For instance, FIG. 7 shows 3 search results, with a thumbnail for each of the search results.

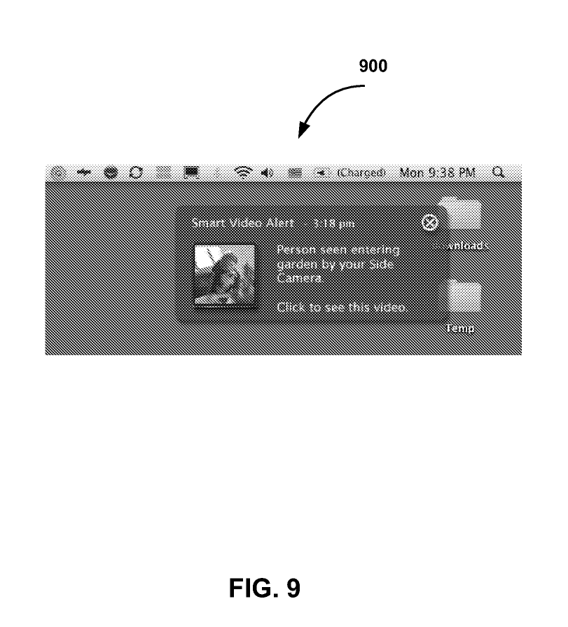

The method 200 may include steps that are not shown in FIG. 2. The method 200 may include the step of receiving a selection of at least one delivery option for the search result. A non-exhaustive and exemplary list of delivery options includes an electronic mail message delivery, a text message delivery, a multimedia message delivery, a forwarding of a web link delivery option, an option to upload the search result onto a website, and any combination thereof. The method 200 may include the step of delivering the search result based on the delivery option selected. The method 200 may also include the step of providing an alert for display on the display of the computing device 120. An exemplary alert is a pop-up alert 900 in FIG. 9 which shows a thumbnail of a frame from a video clip.

FIG. 3 is an exemplary system 300 for providing an analysis. The system 300 may include four modules, namely, a target identification module 310, an interface module 320, a search result module 330, and a display module 340. The system 300 can utilize any of the various exemplary methods described herein, including the method 200 (FIG. 2) described earlier herein. It will be appreciated by one skilled in the art that any of the modules shown in the exemplary system 300 can be combined, omitted, or modified, and still fall within the scope of various embodiments.

According to one exemplary embodiment, the target identification module 310 is configured for identifying a target from the video supplied to a computing device 120 (FIG. 1). The interface module 320 is in communication with the target identification module 310. The interface module 320 is configured for receiving a query related to the identified target via a user input to the computing device. The search result module 330 is in communication with the interface module 320. The search result module 330 is configured for generating a search result based on the video. The search result may include information related to the identified target. The display module 340 is in communication with the search result module. The display module 340 is configured to display the search result through the display of the computing device 120.

The search result module 340 is configured to filter the video based on the query. The search result module 340 may be configured to provide the video with a text description of the information related to the identified target. The information related to the identified target may include metadata associated with the clip of the video, or it may include all or part of the query. The search result module 340 is also configured to provide a thumbnail of the video clip, as described earlier herein.

The system 300 may comprise a processor (not shown) and a computer readable storage medium (not shown). The processor and/or the computer readable storage medium may act as one or more of the four modules (i.e., the target identification module 310, the interface module 320, the search result module 330, and the display module 340) of the system 300. It will be appreciated by one of ordinary skill that examples of computer readable storage medium may include discs, memory cards, servers and/or computer discs. Instructions may be retrieved and executed by the processor. Some examples of instructions include software, program code, and firmware. Instructions are generally operational when executed by the processor to direct the processor to operate in accord with embodiments of the invention. Although various modules may be configured to perform some or all of the various steps described herein, fewer or more modules may be provided and still fall within the scope of various embodiments.

Turning to FIG. 4, an exemplary screenshot of a rule editor 400 as depicted on a display of a computing device 120 (FIG. 1) is shown. The rule editor 400 is a feature of the technology that allows the user to define one or more aspects of a given rule or query 405. In FIG. 4, a rule name for a given rule (such as a rule name of “People in the garden”) is provided in a name field 410. Preferably, the rule editor 400 allows the user to provide names to the rule 405 that the user defines or otherwise composes.

Still referring to FIG. 4, a plurality of icons may be provided to the user 420. An icon of a video source 440 may be provided. The video source 440 may be displayed with one or more settings, such as the location of the camera (“Video source: Side camera” in FIG. 4). A user may click on the video source icon 440, drag it across to another portion of the display, and drop it in an area of the display. The dragged and dropped icon then becomes a selected side camera video source icon 445 (“Video source: Side camera”), which is shown on FIG. 4 as being located near the center of the display. Alternatively, a user may click on the video source icon 440 until a corresponding icon of the selected video source 445 (with a setting, such as the location of the selected video source) is depicted in the rule 405. Alternatively, the user may be provided with one or more video sources 440, and the user can select from those video sources 440. A list of possible video sources (not shown) may appear on the display. Preferably, the list of possible video sources (not shown) may appear on a right portion of the display. Alternatively, as described previously herein, the user may add, remove, or modify one or more icons (such as the video source icon 440) from the display through one or more user interfaces, such as an “Add” button, drop down menu(s), menu command(s), one or more radio button(s), and any combination thereof. Such icons include but are not limited to icons representing triggers, targets, and responses.

Once a video source 440 is selected and displayed as part of the rule 405 (such as the selected side camera video source icon 445), the user may define the target that is to be identified by a computing device. Preferably, the user may select the “Look for” icon 450 on a left portion of the display of the computing device. Then, a selection of preprogrammed targets is provided to the user. The user may select one target (such as “Look for: People” icon 455 as shown in the exemplary rule 405 of FIG. 4).

The user may select one or more triggers. The user may select a trigger via a user input to the computing device 120. A plurality of trigger icons 460, 465 may be provided to the user for selection. Trigger icons depicted in FIG. 4 are the “Where” icon 460 and the “When” icon 465. If the “Where” icon 460 is selected, then the “Look Where” pane 430 on the right side of the display may be provided to the user. The “Look Where” pane 430 allows for the user to define the boundaries of a location or region that the user wants movements to be monitored. For instance, the user may define the boundaries of a location by drawing a box, a circle, or any other shape. In FIG. 4, the user has drawn a bounding box around an area that is on the left hand side of a garbage can. The bounding box surrounds an identified target. The bounding box may be used to determine whether a target has entered a region or it serves as a visual clue to the user where the target is in the video. Regions may be named by the user. Likewise, queries or rules may be named by the user. Regions, queries and/or rules may be saved by the user for later use. Rules may be processed in real time.

The bounding box may track an identified target. Preferably, the bounding box may track an identified target that has been identified as a result of an application of a rule. The bounding box may resize based on the dimensions of the identified target. The bounding box may move such that it tracks the identified target as the identified target moves in a video. For instance, a clip of a video may be played back, and during playback, the bounding box may surround and/or resize to the dimensions of the identified target. If the identified target moves or otherwise makes an action that causes the dimensions of the identified target to change, the bounding box may resize such that it may surround the identified target while the identified target is shown in the video, regardless of the changing dimensions of the identified target. FIG. 7 shows an exemplary bounding box 775. One skilled in the art will appreciate that one or more bounding boxes may be shown to the user to assist in tracking one or more identified targets while a video is played.

Also, the “Look Where” pane 430 may allow the user to select a radio button that defines the location attribute of the identified target as a trigger. The user may select the option that movement “Anywhere” is a trigger. The user may select the option that “inside” a designated region (such as “the garden”) is a trigger. Similarly, the user may select “outside” a designated region. The user may select an option that movement that is “Coming in through a door” is a trigger. The user may select an option that movement that is “Coming out through a door” is a trigger. The user may select an option that movement that is “Walking on part of the ground” (not shown) is a trigger. In other words, the technology may recognize when an object is walking on part of the ground. The technology may recognize movement and/or object in three-dimensional space, even when the movement and/or object is shown on the video in two dimensions. Further, the user may select an option of “crossing a boundary” is a selected trigger.

If the “When” icon 465 is selected, then the “Look When” pane (not shown) on the right side of the display is provided to the user. The “Look When” pane may allow for the user to define the boundaries of a time period that the user wants movements to be monitored. Movement may be monitored when motion is visible for more than a given number of seconds. Alternatively, movement may be monitored for when motion is visible for less than a given number of seconds. Alternatively, movement may be monitored within a given range of seconds. In other words, a specific time duration may be selected by a user. One skilled in the art that any measurement of time (including, but not limited to, weeks, days, hours, minutes, or seconds) can be utilized. Also, one skilled in the art may appreciate that the user selection can be through any means (including, but not limited to, dropping and dragging icons, checkmarks, selection highlights, radio buttons, text input, and the like).

Still referring to FIG. 4, once a target has been identified and a trigger has been selected, a response may be provided. One or more of a plurality of response icons (such as Record icon 470, Notify icon 472, Report icon 474, and Advanced icon 476) may be selected by the user. As shown in the example provided in FIG. 4, if the Record icon 470 is selected by the user, then “If seen: Record to video” 490 appears on the display of the computing device 120. If read in its entirety, the rule 405 of FIG. 4 entitled “People in the garden” states that using the side camera as a video source, look for people that are inside the garden. If the rule is met, then the response is: “if seen, record to video” (490 of FIG. 4).

If the Notify icon 472 is selected, then a notification may be sent to the computing device 120 of the user. A user may select the response of “If seen: Send email” (not shown) as part of the notification. The user may drag and drop a copy of the Notify icon 472 and then connect the Notify icon 472 to the rule 405.

As described earlier, a notification may also be sending a text message to a cell phone, sending a multimedia message to a cell phone, or a notification by an automated phone. If the Report icon 474 is selected, then a generation of a report may be the response. If the Advanced icon 476 is selected, the computer may play a sound to alert the user. Alternatively the computer may store the video onto a database or other storage means associated with the computing device 120 or upload a video directly to a user-designated URL. The computer may interact with external application interfaces, or it may display custom text and/or graphics.

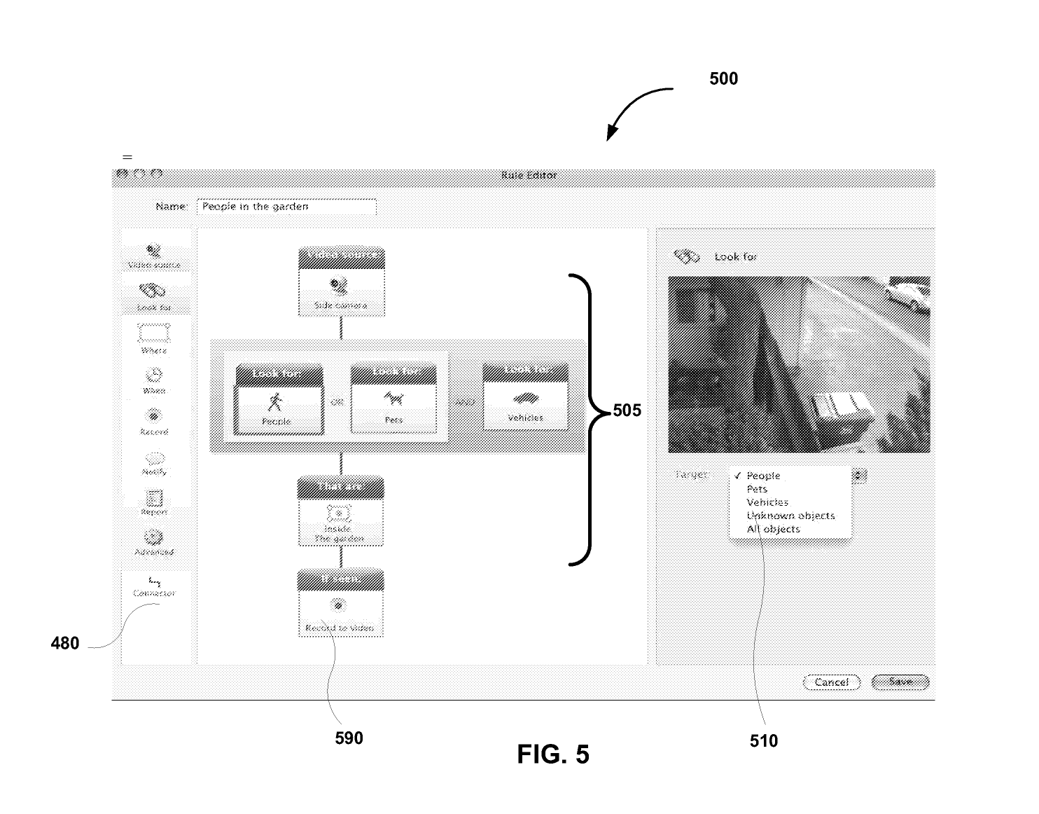

FIG. 5 shows a screenshot 500 of a display of a computing device 120, where a rule 505 is known as a complex rule. The user may select one or more target(s), one or more trigger(s), and any combination thereof, and may utilize Boolean language (such as “and” and “or”) in association with the selected target(s) and/or trigger(s). For example, FIG. 5 shows Boolean language being used with targets. When the user selects the “Look for” icon 450, the user may be presented with a selection list of possible targets 510, which include People, Pets, Vehicles, Unknown Objects and All Objects. The selection list of possible targets 510 may be a drop down menu. The user may then select the targets he or she wishes to select. In the example provided in FIG. 5, the user selected targets in such a way that the program will identify targets that are either People (“Look for: People”) or Pets (“Look for: Pets”), and the program will also look for targets that are Vehicles (“Look for: Vehicles”). The selection list of possible targets 510 may include an “Add object” or “Add target” option, which the user may select in order to “train” the technology to recognize an object or a target that was previously unknown or not identified by the technology. The user may select a Connector icon 480 to connect one or more icons, in order to determine the logic flow of the rule 505 and/or the logic flow between icons that have been selected.

Another embodiment is where Boolean language is used to apply to multiple triggers for a particular target. For instance, Boolean language may be applied, such that the user has instructed the technology to locate a person “in the garden OR (on the sidewalk AND moving left to right).” With this type of instruction, the technology will locate either persons in the garden or persons that are on the sidewalk who are also moving left to right. As mentioned above, one skilled in the art will recognize that the user may include Boolean language that apply for both one or more targets(s) as well as one or more trigger(s).

A further embodiment is a rule 505 that includes Boolean language that provides a sequence (such as “AND THEN”). For instance, a user may select two or more triggers to occur in a sequence (e.g., “Trigger A” happens AND THEN “Trigger B” happens. Further, one skilled in the art will understand that a rule 505 includes one or more nested rules, as well as one or more rules in a sequence, in a series, or in parallel. Rules may be ordered in a tree structure with multiple branches, with one or more responses coupled to the rules.

As shown in FIG. 5, the user may select the targets by placing checkmarks next to the targets he wishes to designate in the selection list of possible targets 510. However, one skilled in the art can appreciate that the selection of targets can be accomplished by any means of selection, and the selection of targets is not limited to highlighting or placing checkmarks next to selected targets.

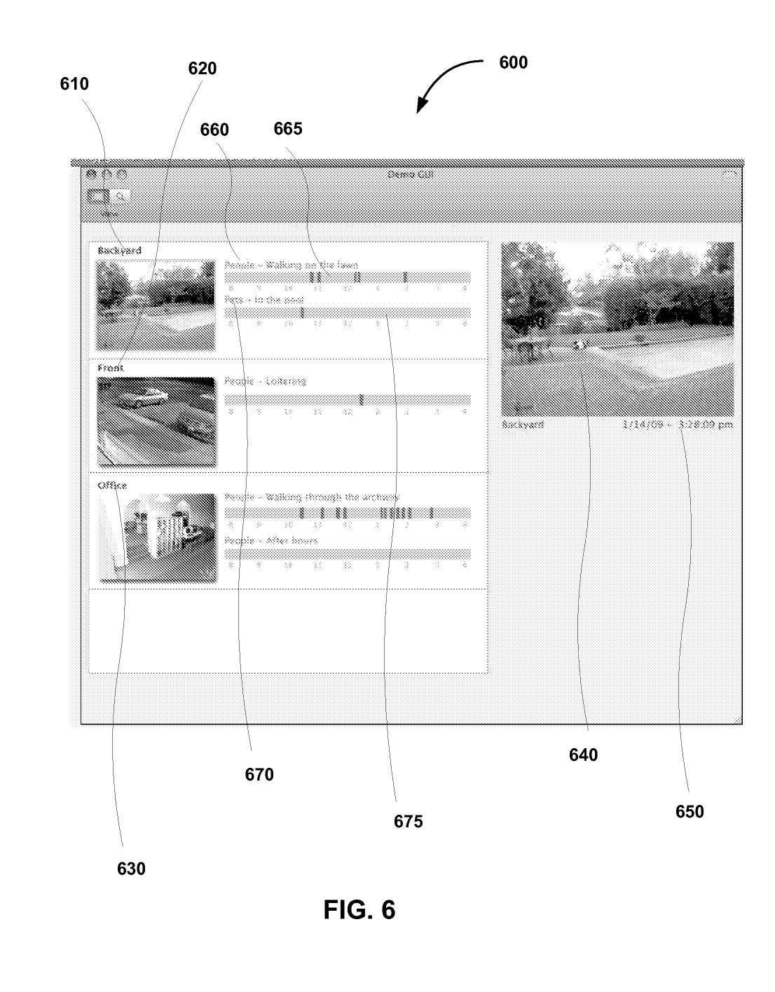

Now referring to FIG. 6, a monitor view 600 of the one or more video sources 130 (FIG. 1) is provided. The monitor view 600 provides an overall glance of one or more video sources 130, in relation with certain timelines of triggered events and rules established by users. Preferably, the monitor view 600 is a live view of a selected camera. The monitor view 600 may provide a live thumbnail of a camera view. The timelines of triggered events may be representations of metadata that are identified and/or extracted from the video by the software program.

In the example provided in FIG. 6, the monitor view 600 includes thumbnail video views of the Backyard 610, Front 620, and Office 630. Further, as depicted in FIG. 6, the thumbnail video view of the Backyard 610 is selected and highlighted on the left side of the display. On the right hand of the display, a larger view 640 of the video that is presented in the thumbnail video view of the Backyard 610 may be provided to the user, along with a time and date stamp 650. Also, the monitor view 600 may provide rules and associated timelines. For instance, the video source 130 located in the Backyard 610 has two rule applications, namely, “People—Walking on the lawn” 660 and “Pets—In the Pool” 670. A first timeline 665 is associated with the rule application “People—Walking on the lawn” 660. Similarly, a second timeline 675 is associated with the rule application “Pets—In the Pool” 670. A rule application may comprise a set of triggered events that meet requirements of a rule, such as “People in the garden” 405 (FIG. 4). The triggered events are identified in part through the use of metadata of the video that is recognized, extracted or otherwise identified by the program.

The first timeline 665 is from 8 am to 4 pm. The first timeline 665 shows five vertical lines. Each vertical line may represent the amount of time in which movement was detected according to the parameters of the rule application “People—Walking on the lawn” 660. In other words, there were five times during the time period of 8 am to 4 pm in which movement was detected that is likely to be people walking on the lawn. The second timeline 675 is also from 8 am to 4 pm. The second timeline 675 shows only one vertical line, which means that in one time period (around 10:30 am), movement was detected according to the parameters of the rule application “Pets—In the Pool” 670. According to FIG. 6, around 10:30 am, movement was detected that is likely to be one or more pets being in the pool.

FIG. 7 shows a screenshot 700 of a display of a computing device 120 following the execution of a quick search, according to one exemplary embodiment. The quick search option 710 is one of two options for searching in FIG. 7. The second option is a rule search option 720, which will be discussed in greater detail in FIG. 8. A quick search may allow for a user to quickly search for videos or clips of videos that meet certain criteria. The criteria may include information provided in a location field 730, a target field 740, and a duration field 750. Searches may be done immediately upon receipt of the criteria. Searches may be done on live video and/or archived video.

In FIG. 7, the user has selected “Living room” for the location of the camera (or video source) in the location field 730, “people” for identified targets to look for in the target field 740, and “anytime” as the criteria for the timestamp of the video to be searched in the duration field 750. In other words, with this set of criteria, the user has asked for a quick search of videos that have been captured by the living room camera. The exemplary quick search in FIG. 7 is to identify all the triggered events in which people were in the living room at anytime. By doing so, the quick search may narrow the video clips from a huge set to a much smaller subset, where the subset conforms to the user's query or search parameters.

Search results may filter existing video to display to the user only the relevant content. In the case of quick searches, the relevant content may be that content which matches or fits the criteria selected by the user. In the case of rule searches (which will be discussed at length in conjunction with FIG. 8), the relevant content may be that content which matches or fits the rule defined and selected by the user. The technology may use object recognition and metadata associated with video clips in order to conduct a search and generate a search result.

In FIG. 7, the quick search has provided a search result of only three video clips. The three video clips may be listed in a chronological order, with a thumbnail of a frame showing the identified target and a bounding box. Each of the three video clips includes a text description of “People—Living room.” The text description may have been generated from information related to the identified objects and/or metadata associated with the video clips.

In FIG. 7, one of the three video clips 760 is highlighted and selected by the user. Once a video clip is selected, a larger image 765 of the video clip 760 is provided to the user on the display of the computing device 120. The larger image 765 may include a bounding box 775 of the identified target that matched the executed search criteria or rule. Videos may start playing at the frame where the identified target matched the executed search. The larger image 765 may also include a title 770, such as “Living room,” to indicate the setting or location of the camera or video source.

Controls for videos 780 may be provided to the user. The user may be able to playback, rewind, fast forward, or skip throughout a video using the appropriate video controls 780. The user may also select the speed in which the user wishes to view the video using a playback speed control 785. Also, a timeline control 790 that shows all the instances of a current search over a given time period may be displayed to the user. In FIG. 7, the exemplary timeline control 790 is a timeline that stretches from 8 am to 6 pm, and it shows each instance of a search result that matches the quick search criteria 730, 740, and 750. When a user highlights or otherwise selects a video clip from the results of a quick search, a corresponding vertical line that represents the time interval of the video clip in relation to the timeline may be also highlighted.

Turning to FIG. 8, FIG. 8 shows a screenshot 800 of a display of a computing device 120 following the execution of a rule search. The rule search option 720 has been selected by the user in the example of FIG. 8. A rule search is a search based on a user-defined rule. A rule may include a target and a trigger. By virtue of the fact that targets and triggers can be defined by users, rules and portions of rules are user-extensible. Further information regarding rules may be found in the U.S. patent application Ser. No. ______ filed on Feb. 9, 2009, titled “Systems and Methods for Video Monitoring,” which is hereby incorporated by reference.

A rule may be saved by a user. In FIG. 8, three rules have been saved by the user. Those rules are called “Approaching the door,” “Climbing over the fence into the garden” and “Loitering by the fence.” Saved rules may be displayed in a rule list 810. One of the saved rules may be selected, along with a definition of a time frame through the duration field 750, to execute a rule search. In the example provided in FIG. 8, the rule “Climbing over the fence into the garden” has been selected by the user and the time frame is “anytime.” Thus, the exemplary rule search in FIG. 8 is for the technology to search any videos that show an object climbing over the fence into the garden at anytime.

As earlier described, rules may be modified or edited by a user. A user may edit a rule by selecting a rule and hitting the “Edit” button 820. Thus, a user may change any portion of a rule using the “Edit” button. For instance, a user may select a rule and then the user may be presented with the rule as it currently stands in the rule editor 400 (FIG. 4). The user may edit the rule by changing the flow logic of a rule or by modifying the targets, triggers, and/or responses of the existing rule. A new rule may be created as well, using the rule editor 400, and then the user may save the rule, thereby adding the new rule to the rule list 810.

Rules may be uploaded and downloaded by a user to the Internet, such that rules can be shared amongst users of this technology. For example, a first user may create a sprinkler rule to turn on the sprinkler system when a person jumps a fence and enters a region. The first user may then upload his sprinkler rule onto the Internet, such that a second user can download this the first user's sprinkler rule. The second user may then use the first user's sprinkler rule in its entirety, or the second user may modify the first user's sprinkler rule to add that if a pet jumps the fence and enter the region, then the sprinkler will also activate. The second user may then upload the modified sprinkler rule onto the Internet, such that the first user and any third party may download the modified sprinkler rule.

Also, rules may be defined for archival searches. In other words, videos may be archived using a database or an optional video storage module (not shown) in the system 300 (FIG. 3). Rules may be selected for execution and application on those archived videos. Based on historical learning, after archived videos have been recorded, a user may also execute a new rule search on archived videos. The user may define a new rule, the user may use another user's rules that have been shared, or the user may download a new rule from the Internet. The optional video storage module (not shown) in the system 300 may be referenced in to do a subsequent analysis or application of rules.

Turning now to FIG. 9, as previously discussed, the technology includes a pop-up alert 900. The pop-up alert 900 may be for display on the display of the computing device 120. The pop-up alert 900 includes a thumbnail of a frame from a video clip. In the exemplary pop-up alert 900, text may be presented to the user in the pop-up alert 900, advising the user that a person was seen entering the garden via the side camera, based on object recognition, historical learning, and metadata associated with the video clip. The pop-up alert 900 may be a result of a rule application where the user has requested the system to inform the user when persons are seen entering the garden via the side camera. The pop-up alert 900 may include an invitation for the user to view the relevant video clip provided by the side camera. This pop-up alert 900 may also include a timestamp, which may also be provided by metadata associated with the video clip.

The technology mentioned herein is not limited to video. External data sources, such as web-based data sources, can be utilized in the system 100 of FIG. 1. Such external data sources may be used either in conjunction with or in place of the one or more video sources 130 in the system 100 of FIG. 1. For instance, the technology encompasses embodiments that include data from the Internet, such as a news feed. The system 100 of FIG. 1 allows for such a rule and response to be defined by a user and then followed by the system 100. Preferably, a rule includes a target and a trigger. However, in some embodiments, a rule may include a target, a trigger, a response, and any combination thereof.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

1. A method for providing an analysis, the method comprising:
identifying a target by a computing device, the target being displayed from a video through a display of the computing device;
receiving a query related to the identified target via a user input to the computing device;
generating a search result based on the video, the search result comprising information related to the identified target, and
displaying the search result through the display of the computing device.

2. The method of claim 1, wherein generating the search result based on the video further comprises filtering the video based on the query.

3. The method of claim 1, wherein generating the search result further comprises providing a clip of the video with a text description of the information related to the identified target.

4. The method of claim 3, wherein the information related to the identified target includes metadata associated with the clip of the video.

5. The method of claim 3, wherein generating the search result further comprises providing a thumbnail of the clip of the video.

6. The method of claim 5, wherein the thumbnail includes a bounding box surrounding the identified target.

7. The method of claim 5, wherein the thumbnail includes a frame of the clip of the video, the frame being where the identified target matches the query.

8. The method of claim 1, wherein the query further comprises a user-defined rule.

9. The method of claim 1, wherein at least one of the query and the search result is stored on a computer readable storage medium.

10. The method of claim 3, wherein the query comprises an instruction to provide the clip of the video based on a specified time period.

11. The method of claim 3, wherein the query comprises an instruction to provide the clip of the video from a video source.

12. The method of claim 11, wherein the video source comprises one of an IP camera, a web camera, a security camera, a video camera, a video recorder, and any combination thereof.

13. The method of claim 3, wherein the query comprises an instruction to provide the clip of the video regarding the identified target, the identified target comprising a person, a vehicle or a pet.

14. The method of claim 3, wherein the query comprises an instruction to provide the clip of the video showing an identified target within a region.

15. The method of claim 1, wherein the target comprises one of a recognized object, a motion sequence, a state, and any combination thereof.

16. The method of claim 1, wherein identifying the target from the video further comprises receiving a selection of a predefined object.

17. The method of claim 1, wherein identifying the target from the video further comprises recognizing an object based on a pattern.

18. The method of claim 17, wherein the recognized object is at least one of a person, a pet and a vehicle.

19. The method of claim 1, wherein the video comprises one of a video feed, a video scene, a captured video, a video clip, a video recording, and any combination thereof.

20. The method of claim 1, further comprising receiving a selection of at least one delivery option for the search result.

21. The method of claim 20, wherein the delivery option comprises an electronic mail message delivery, a text message delivery, a multimedia message delivery, a forwarding of a web link delivery option, an option to upload the search result onto a website, and any combination thereof.

22. The method of claim 20, further comprising delivering the search result based on the delivery option selected.

23. The method of claim 3, wherein generating the search result further comprises providing a timeline showing triggered events that occur within a specified time period, as shown in the clip of the video.

24. The method of claim 3, wherein displaying the search result further comprises providing a playback of the clip of the video.

25. The method of claim 3, further comprising providing an alert for display on the display of the computing device.

26. A system for providing an analysis, the system comprising:
a target identification module configured for identifying a target from a video supplied to a computing device;
an interface module in communication with the target identification module, the interface module configured for receiving a query related to the identified target via a user input to the computing device;
a search result module in communication with the interface module, the search result module configured for generating a search result based on the video, the search result comprising information related to the identified target; and
a display module in communication with the search result module, the display module configured for displaying the search result through the display of the computing device.

27. The system of claim 26, wherein the search result module is configured to filter the video based on the query.

28. The system of claim 26, wherein the search result module is configured to provide the clip of the video with a text description of the information related to the identified target.

29. The system of claim 28, wherein the information related to the identified target includes metadata associated with the clip of the video.

30. The system of claim 28, wherein the search result module is configured to provide a thumbnail of the clip of the video.

31. A system for generating a search result based on an analysis, the system comprising:
a processor;
a computer readable storage medium having instructions for execution by the processor which causes the processor to generate a search result;
wherein the processor is coupled to the computer readable storage medium, the processor executing the instructions on the computer readable storage medium to:
identify a target from a video supplied to a computing device;
receive a query related to the identified target; and
generate the search result based on the video, the search result comprising information related to the identified target.

32. The system of claim 31, further comprising a display for displaying the search result.

33. The system of claim 31, wherein the computer readable storage medium further includes the instruction to provide a clip of the video with a text description of the information related to the identified target.
